(19) United States
(12) Patent Application Publication
(10) Pub. No.: US 2026/0117061 A1
(43) Pub. Date: Apr. 30, 2026

(54) AMINATED EPOXY CARDANOL GLYCIDYL ETHER COMPATILIZER, PREPARATION METHOD AND APPLICATION THEREOF

(71) Applicant: Beijing Technology and Business University, Beijing (CN)

(72) Inventors: Xinyu SONG, Beijing (CN); Yunxuan WENG, Beijing (CN); Caili ZHANG, Beijing (CN); Xiaoqian DIAO, Beijing (CN)

(21) Appl. No.: 19/011,821

(22) Filed: Jan. 7, 2025

(30) Foreign Application Priority Data
Oct. 24, 2024 (CN) 202411496901.4

(51) Int. Cl. C08L 67/04; B29C 64/118; B29C 64/314; B29K 67/00; B29K 105/00; B29K 105/12; B29K 511/14; B33Y 10/00; B33Y 40/10; B33Y 70/10; C07F 7/18; C08G 18/08

(52) U.S. Cl. CPC C08L 67/04; B29C 64/118; B29C 64/314; B33Y 10/00; B33Y 40/10; B33Y 70/10; C07F 7/1892; C08G 18/0809; B29K 2067/046; B29K 2105/0005; B29K 2105/12; B29K 2511/14; C08L 2205/08; C08L 2205/16

(57) ABSTRACT

An aminated epoxy cardanol glycidyl ether (NH₂—NC514) compatilizer, a preparation method and an application are provided, and the NH₂—NC514 is prepared by self-polymerization reaction of NC514 and grafting reaction with hydrolyzed KH550. When NH₂—NC514 is mixed with polylactic acid and bamboo fibers as a compatibilizer, a bio-based degradable bamboo-plastic composite material with excellent processing fluidity and mechanical properties can be obtained. The composite material is used for preparing the 3D printed product.

### CROSS-REFERENCE TO RELATED APPLICATIONS

This application claims priority to Chinese Patent Application 202411496901.4, filed on Oct. 24, 2024, the contents of which are hereby incorporated by reference.

### TECHNICAL FIELD

The disclosure relates to the technical field of plastic additives, in particular to an aminated epoxy cardanol glycidyl ether compatilizer, a preparation method and an application thereof.

### BACKGROUND

Polylactic acid/bamboo fibers composites used for fused deposition molding (FDM) 3D printing filaments have the advantages of environmental sustainability, light weight, high strength, unique appearance and texture, and low costs. With flexible design and manufacturing capabilities, polylactic acid/bamboo fibers composites can meet the needs of sophisticated manufacturing industries for complex structural parts and personalized and differentiated products, and have a good commercial prospect. However, it is still rare to see continuous plant fiber reinforced composites applied in 3D printing technology, mainly because there are a large number of polar hydroxyl groups (alcoholic hydroxyl groups and phenolic hydroxyl groups) on the surface of bamboo fibers (BFs), and their strong water absorption and intermolecular force make BFs less dispersible during thermal plasticization. When melt blending with hydrophobic polylactic acid (PLA) resin, the interfacial compatibility between FBs and PLA is poor. When preparing composites filled with high fiber content, the processing fluidity and mechanical properties are poor, and problems such as broken wires and blocked nozzles occur during extrusion and 3D printing, which negatively affect the dimensional stability and printing accuracy of products.

At present, researchers have conducted extensive research on the performance modification of fiber reinforced composites, mainly focusing on the surface treatment of fibers and the modification of polymer matrix. The purpose of fiber surface treatment is to reduce the surface polarity of fiber and improve the surface roughness, so as to improve the interface bonding with polymer matrix. The fiber surface treatment ways include physical and chemical ways, the former are steam explosion and high temperature carbonization, and the later are alkali treatment and silane coupling agent treatment. However, physical ways require high requirements for equipment and consume considerable energy. The complicated steps of chemical ways make it difficult for industrial production.

It has been the top choice to introduce modifiers directly in the melt blending stage when new modified materials are prepared in a green and efficient way. Thermodynamically immiscible polymer blends are often effectively compatibilized by non-in-situ and in-situ reactive compatibilizers. Although non-in-situ reactive compatibilizers can make fiber reinforced composites show excellent physical properties and processability by reducing interfacial tension and strengthening interphase bonding, in the process of thermal plasticization, due to the lack of chemical reaction, macromolecular chains are prone to depolymerization and entanglement; and when the compatibilizer is excessive, it is easy to agglomerate and form a phase separation structure, and the compatibilization efficiency is low.

By using in-situ reactive compatibilizers with reactive functional groups (anhydride, isocyanate, etc.), the low melt viscosity can be diffused to the surface of the blends in a short time and efficiently, and the graft copolymer is formed by the reaction of active groups with polar groups on the fiber surface and terminal groups on the matrix, thus realizing the surface treatment of the fiber and the modification of the polymer matrix. However, there is often a problem that the mechanical properties of composites decrease in a short time due to the molecular migration of compatibilizers, which cannot ensure the service stability of products in high temperature and humid environment.

Therefore, it is urgent to develop a bio-based compatibilizer with high synthesis efficiency, high reaction activity, good compatibility modification and migration resistance.

### SUMMARY

The purpose of the disclosure is to provide an aminated epoxy cardanol glycidyl ether compatilizers, a preparation method and an application, so as to solve the problems existing in the prior art. According to the disclosure, epoxy cardanol glycidyl ether (NC514) is used as a raw material, self-polymerization of NC514 is initiated and amino groups are introduced for grafting modification, so that NC514 forms a three-dimensional network polymer. The intermolecular interaction force is improved by increasing the molecular weight of NC514 and the chemical sites reacting with bamboo fibers (BFs) and polylactic acid (PLA). The molecular structure of the compatilizer is regulated by controlling the reaction conditions of self-polymerization and grafting. The adjustment of the molecular structure not only enhances the migration resistance, but also enhances the service stability of the composite, thus providing a promising strategy for realizing the thermoplastic processing of the highly filled bamboo-plastic composite and the preparation of high-performance 3D printed product.

In order to achieve the above objectives, the disclosure provides the following scheme:
according to one technical scheme of the disclosure, an aminated epoxy cardanol glycidyl ether (NH₂—NC514 for short) has a structural formula as follows:

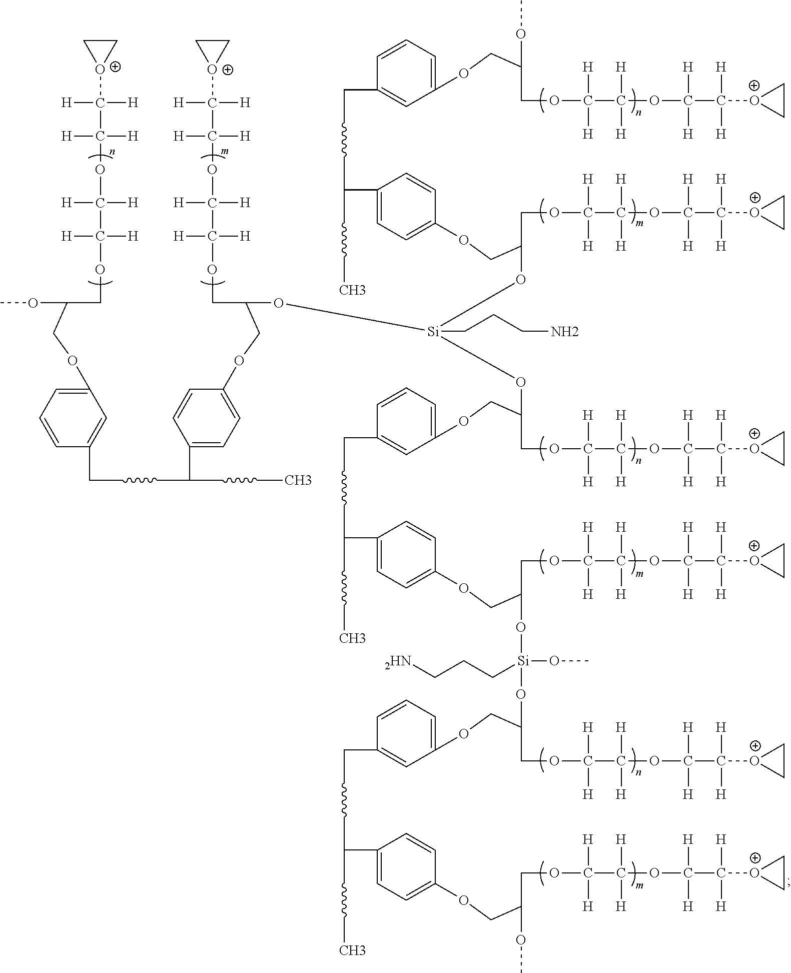

where [symbol] stands for —(CH₂)₆— (alkane chain).
where m is an any natural number; and n is an any natural number.

A second technical scheme of the disclosure is a preparation method of the aminated epoxy cardanol glycidyl ether compatilizer, including following steps:
hydrolyzing 3-aminopropyl triethoxysilane (KH550) to obtain hydrolyzed KH550;
using a cationic initiator to initiate self-polymerization of epoxy cardanol glycidyl ether (NC514) to obtain poly-epoxy cardanol glycidyl ether (poly-NC514); and
taking the poly-NC514 and the hydrolyzed KH550 as reactants, and carrying out grafting reaction to obtain the aminated epoxy cardanol glycidyl ether (NH₂—NC514).

Further, the hydrolyzing KH550

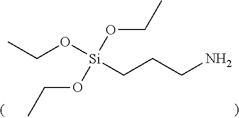

includes: dissolving KH550 in ethanol solution, magnetically stirring for 30-90 minutes (min), optionally 30 min, and completing the hydrolysis reaction to obtain the hydrolyzed KH550.

Optionally, a volume fraction of the ethanol solution is 60%.

Optionally, a dissolved concentration of KH550 in ethanol solution is 2 wt. % (that is, the dissolved concentration of KH550 in the mixed system is 2 wt. %).

Optionally, a temperature of the hydrolysis reaction is room temperature.

Further, a structural formula of the hydrolyzed KH550 is

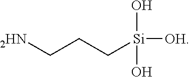

Further, steps of initiating the self-polymerization of NC514 with the cationic initiator includes:
dissolving the cationic initiator and NC514 in a solvent, and stirring vigorously for 5-10 min at room temperature to initiate the self-polymerization of NC514 to obtain the poly-NC514.

Optionally, the solvent is a mixture of acetone, ethanol, xylene and n-butanol with a volume ratio of 7:3 or propylene glycol methyl ether; and optionally the solvent is acetone. Acetone as a solvent has good dissolution effects and rapid volatilization.

Optionally, the cationic initiator is boron trifluoride ethylamine complex (BF₃NH₂Et).

Optionally, a dosage of the cationic initiator is 1-2 wt. % of the dosage of NC514.

Optionally, a temperature of the self-polymerization is room temperature.

Optionally, a weight-average molecular weight of the poly-NC514 is 900-1500 g/mol.

Further, steps of grafting reaction with poly-NC514 and hydrolyzed KH550 as reactants includes: dissolving the poly-NC514 in the hydrolyzed KH550 and stirring for 30-60 min to complete the grafting reaction (amino grafting modification reaction) to obtain the NH₂—NC514.

Optionally, a mass ratio of the poly-NC514 to the hydrolyzed KH550 is 3-1:1-3, more optionally 3:1, 1:1 or 1:3.

Optionally, a temperature of the grafting reaction is room temperature.

Optionally, after the completion of the grafting reaction, the grafting reaction product is further dried in a vacuum oven at 80° C. for 12 hours.

Optionally, a weight-average molecular weight of NH₂—NC514 is 5000-12000 g/mol, more optionally 8000 g/mol.

Reaction conditions of self-polymerization and grafting reaction will affect the molecular weight of NH₂—NC514. By adjusting reaction conditions of self-polymerization (including a time of self-polymerization and an amount of the cationic initiator) and grafting reaction (including a ratio of an amount of poly-NC514 to hydrolyzed KH550 and a duration of grafting reaction), NH₂—NC514 with any molecular weight in the weight-average molecular weight of 5000-12000 g/mol is obtained.

A third technical scheme of the disclosure is the application of the aminated epoxy cardanol glycidyl ether as a compatilizer in a preparation of a 3D printing composite material.

A fourth technical scheme of the disclosure is a 3D printing composite material, including following raw materials in parts by mass: 70 parts of PLA, 30 parts of BFs and 2-8 parts of compatilizer; and the compatilizer is the aminated epoxy cardanol glycidyl ether.

NH₂—NC514, as a compatilizer of matrix materials (PLA and BFs) of 3D printing composites, makes the matrix materials have excellent interface compatibility, mechanical properties, processability and service stability.

Optionally, a dosage of the compatilizer is 4-8 parts.

A fifth technical scheme of the disclosure is a preparation method of the 3D printing composite material, including following steps:
mixing the PLA, the BFs and the compatilizer at room temperature, and then carrying out banburying and mixing to obtain the 3D printing composite material.

Further, a specific operation of mixing at room temperature is as follows: stirring and mixing for 10-30 min at a rotating speed of 60 rpm at room temperature; a specific operation of banburying and mixing is: stirring and mixing for 8 min at a speed of 60 rpm at a temperature of 190° C.

A sixth technical scheme of the disclosure is a preparation method of a 3D printing product by using the 3D printing composite material, including following steps:
crushing the 3D printing composite material, and then melting and extruding the 3D printing composite material to obtain thermoplastic filaments; and carrying out 3D printing on the thermoplastic filaments to obtain the 3D printed product.

Optionally, a temperature of the melting and extruding is 175-180° C.; and a diameter of the thermoplastic filaments is 1.75±0.03 mm.

Further, before the mixed material is crushed, melted and extruded, the steps also include vacuum drying a crushed 3D printing composite material for 12 h at 80° C. to remove a residual moisture of the 3D printing composite material.

Optionally, the 3D printing is carried out in an FDM printer, and parameters of the FDM printer are set as follows: a nozzle temperature is 190-220° C., a platform temperature is 60-80° C., a printing speed is 40-80 mm/s, and a layer thickness is 0.05-0.25 mm; and the lay thickness is optionally 0.1 mm.

A seventh technical scheme of the disclosure is a 3D printed product prepared by the preparation method.

The matching degree between the material characteristics of continuous plant fiber reinforced composites and 3D printing technology is not high, so it is still rare to see continuous plant fiber reinforced composites applied in 3D printing technology. According to the application, aminated epoxy cardanol glycidyl ether which is diffused to the surface of the blend in a short time and efficiently is directly added as a compatilizer during melt blending, and at the same time, the surface treatment of fibers and the modification of polymer matrix are realized, so that a fully bio-based degradable bamboo-plastic composite material (3D printing composite material) with excellent processing fluidity and mechanical properties is prepared. When the 3D printing composite material is used for 3D printing, 3D printing products prepared by adjusting nozzle temperature, printing layer height, printing speed and filling rate not only have excellent mechanical properties, thermal properties, appearance quality and processability, but also have excellent aging resistance and service stability.

The disclosure discloses following technical effects:
the disclosure provides a novel bio-based compatilizer aminated epoxy cardanol glycidyl ether (NH₂—NC514) for PLA/BFs composite material. In the application, the reactive migration-resistant compatilizer NH₂—NC514 with a three-dimensional network structure with high synthesis efficiency, high reactivity, good compatibility modification and migration resistance is prepared by initiating the self-polymerization of NC514 and introducing amino groups for grafting modification. By increasing the molecular weight of the compatibilizer and the chemical sites that react with BFs and PLA, the intermolecular interaction force is improved. The molecular structure (molecular weight) of the compatibilizer is controlled by controlling the reaction conditions of self-polymerization and grafting. The adjustment of molecular structure (molecular weight) can not only enhance the migration-resistance, but also enhance the service stability of composites. When NH₂—NC514 prepared by the application is used as a compatilizer of PLA/BFs composite material, the reaction of active groups such as epoxide group, hydroxyl group and amino group in the structure with polar groups on the surface of BFs and terminal groups of PLA molecular chain can not only promote the effective dispersion of PLA and BFs, but also ensure the uniformity of composite material; and the chemical reaction can also enhance interfacial compatibility, reduce interfacial tension and improve bonding strength. The chemical reaction can play a role in the process of crosslinking and curing, build a solid three-dimensional network, enhance the mechanical and thermal stability of the composite material, and prepare a bio-based degradable bamboo-plastic composite material with excellent processing fluidity and mechanical properties. When the composite material is applied to 3D printing, the 3D printing product not only have excellent mechanical properties, thermal properties, appearance quality and processability, but also have excellent aging resistance and service stability. The problem that high fiber filling cannot realize thermoplastic processing is solved, and the bamboo-plastic 3D printed product with excellent and stable preparation performance is realized.

### BRIEF DESCRIPTION OF THE DRAWINGS

In order to explain embodiments of the disclosure or the technical scheme in the prior art more clearly, the figures needed in the embodiments will be briefly introduced below. Obviously, the figures described below are only some embodiments of the present application, and other figures may be obtained according to these figures without creative work for ordinary people in the art.

FIG. 1 is a structural formula of NH₂—NC514.

FIG. 2A is a structural formula of poly-NC514.

FIG. 2B is a structural formula of hydrolyzed KH550.

FIG. 3 is a chemical reaction formula of poly-NC514 prepared by self-polymerization.

FIG. 4 is a chemical reaction formula of NH₂-ESO prepared by self-polymerization.

FIG. 5 is a reaction mechanism for preparing 3D printing composite material.

FIG. 6 is an infrared spectrum (FTIR) diagram of NH₂—NC514 prepared in Embodiment 1, NH₂-ESO prepared in Comparative embodiment 1 and raw material NC514 and ESO.

FIG. 7A is a surface SEM image of bamboo fibers (BFs) extracted from the 3D printing composite material prepared in Comparative Application Embodiment 3.

FIG. 7B is a surface SEM image of BFs/4NH₂-ESO extracted from the 3D printing composite material prepared in Comparative Application Embodiment 1.

FIG. 7C is a surface SEM image of BFs/4NH₂—NC514 extracted from the 3D printing composite material prepared in Application embodiment 1.

FIG. 8A is a curve resolution XPS C1s spectrogram of BFs extracted from the 3D printing composite material prepared in Comparative application embodiment 3.

FIG. 8B is a curve resolution XPS C1s spectrogram of BFs/4NH₂-ESO extracted from the 3D printing composite material prepared in Comparative application embodiment 1.

FIG. 8C is a curve resolution XPS C1s spectrogram of BFs/4NH₂-ESO extracted from the 3D printing composite material prepared in Comparative application embodiment 2.

FIG. 8D is a curve resolution XPS C1s spectrogram of BFs/4NH₂—NC514 extracted from the 3D printing composite material prepared in Application embodiment 1.

FIG. 8E is a curve resolution XPS C1s spectrogram of BFs/4NH₂—NC514 extracted from the 3D printing composite material prepared in Application embodiment 2.

FIG. 9 is a DSC secondary temperature rise curve of 3D printing composite material prepared by Application embodiments 1-2 and Comparative application embodiments 1-3.

FIG. 10A is a DMA curve of storage modulus of 3D printing composite material prepared by Application embodiments 1-2 and Comparative application embodiments 1-3.

FIG. 10B is a DMA curve of damping parameter of 3D printing composite material prepared by Application embodiments 1-2 and Comparative application embodiments 1-3.

FIG. 11A is a test curve of complex viscosities of rheological properties of 3D printing composite material prepared by Application embodiments 1-2 and Comparative application embodiments 1-3.

FIG. 11B is a test curve of storage modulus of rheological properties of 3D printing composite material prepared by Application embodiments 1-2 and Comparative application embodiments 1-3.

FIG. 12A is a section SEM image of polylactic acid (PLA)/BFs of impact fracture of impact spline prepared by using the 3D printing composite material in Application embodiments 1-2 and Comparative application embodiments 1-3.

FIG. 12B is a section SEM image of PLA/BFs/4NH₂-ESO of impact fracture of impact spline prepared by using the 3D printing composite material in Application embodiments 1-2 and Comparative application embodiments 1-3.

FIG. 12C is a section SEM image of PLA/BFs/8NH₂-ESO of impact fracture of impact spline prepared by using the 3D printing composite material in Application embodiments 1-2 and Comparative application embodiments 1-3.

FIG. 12D is a section SEM image of PLA/BFs/4NH₂—NC514 of impact fracture of impact spline prepared by using the 3D printing composite material in Application embodiments 1-2 and Comparative application embodiments 1-3.

FIG. 12E is a section SEM image of PLA/BFs/8NH₂—NC514 of impact fracture of impact spline prepared by using the 3D printing composite material in Application embodiments 1-2 and Comparative application embodiments 1-3.

FIG. 12F is a surface SEM image of PLA/BFs of impact fracture of impact spline prepared by using the 3D printing composite material in Application embodiments 1-2 and Comparative application embodiments 1-3.

FIG. 12G is a surface SEM image of PLA/BFs/4NH₂-ESO of impact fracture of impact spline prepared by using the 3D printing composite material in Application embodiments 1-2 and Comparative application embodiments 1-3.

FIG. 12H is a surface SEM image of PLA/BFs/8NH₂-ESO of impact fracture of impact spline prepared by using the 3D printing composite material in Application embodiments 1-2 and Comparative application embodiments 1-3.

FIG. 12I is a surface SEM image of PLA/BFs/4NH₂—NC514 of impact fracture of impact spline prepared by using the 3D printing composite material in Application embodiments 1-2 and Comparative application embodiments 1-3.

FIG. 12J is a surface SEM image of PLA/BFs/8NH₂—NC514 of impact fracture of impact spline prepared by using the 3D printing composite material in Application embodiments 1-2 and Comparative application embodiments 1-3.

FIG. 13 is a schematic diagram of thermoplastic filaments extruded by a single screw extruder and then printed in 3D.

### DETAILED DESCRIPTION OF THE EMBODIMENTS

A number of exemplary embodiments of the disclosure will now be described in detail, and this detailed description should not be considered as a limitation of the present application, but should be understood as a more detailed description of certain aspects, characteristics and embodiments of the present disclosure.

It should be understood that the terminology described in the present disclosure is only for describing specific embodiments and is not used to limit the present disclosure. In addition, for the numerical range in the present disclosure, it should be understood that each intermediate value between the upper limit and the lower limit of the range is also specifically disclosed. Intermediate values within any stated value or stated range, as well as each smaller range between any other stated value or intermediate values within the stated range are also included in the present disclosure. The upper and lower limits of these smaller ranges can be independently included or excluded from the range.

Unless otherwise specified, all technical and scientific terms used herein have the same meaning as commonly understood by one of ordinary skill in the art to which this disclosure relates. Although the present disclosure only describes the preferred methods and materials, any methods and materials similar or equivalent to those described herein can also be used in the practice or testing of the present disclosure. All documents mentioned in this disclosure are incorporated by reference to disclose and describe methods and/or materials related to the documents. In case of conflict with any incorporated document, the contents of this specification shall prevail.

It is obvious to those skilled in the art that many improvements and changes can be made to the specific embodiments of the present disclosure without departing from the scope or spirit of the present disclosure. Other embodiments will be apparent to the skilled person from the description of the disclosure. The description and Embodiments of that present disclosure are exemplary only.

The terms “including”, “comprising”, “having” and “containing” used in this article are all open terms, which means including but not limited to.

The raw materials and reagents used in specific embodiments of the disclosure are all commercially available products, among which polylactic acid (PLA) (4032D) is commercially obtained from NatureWorks of the United States, with a weight-average molecular weight (Mw) of 17.62×10⁴ g/mol, a melt flow rate of 7 g/10 min, a melting temperature of 190° C., and a weight quality in a melt index test is 2.16 kg; bamboo fibers (BFs) with a diameter of 0.1-1 μm and a length of 5-50 μm is purchased from Mujiang Weihua Spice Factory, Shuangshui Town, Xinhui District, Jiangmen City, Guangdong Province, China; NC514 is directly used after being purchased from Cardolite Corporation, USA, with CAS number of 68390-54-5 and Mw of 537 g/mol; BF₃NH₂Et is provided by Shanghai Sigma-Aldrich; KH550 is purchased from Beijing Mreda; and acetone and ethanol are provided by Beijing Institute of Chemical Reagents Co., Ltd.

Unless otherwise specified, the “number of copies” mentioned in the specific embodiments of the present application refers to “number of copies by mass”.

Unless otherwise specified, “room temperature” in the specific embodiments of the present disclosure refers to 15-30° C.

In the specific embodiments of the present disclosure, the rotation speed of “magnetic stirring” is 150 r/min, and that of “vigorous stirring” is 280 r/min.

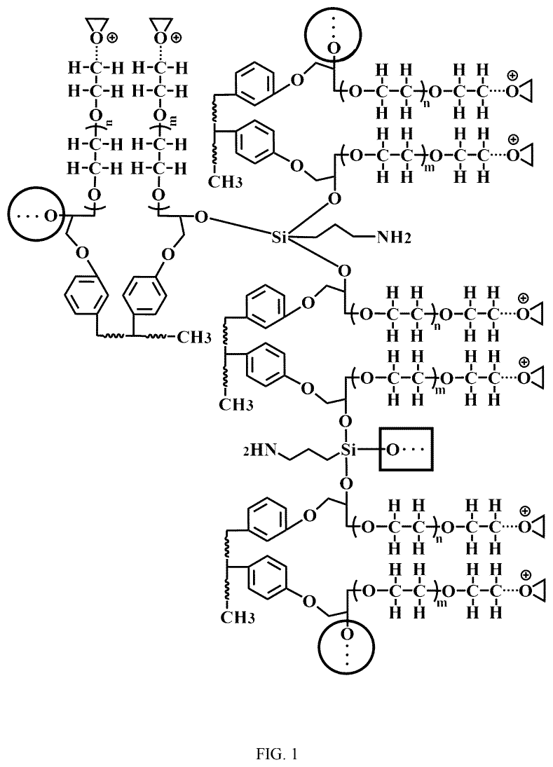

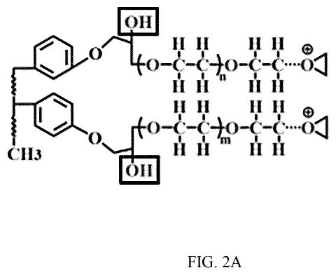

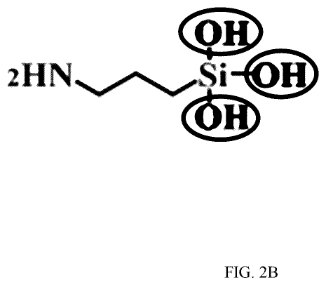

In the specific embodiments of the present disclosure, the structural formulas of the reactants poly-NC514 and hydrolyzed KH550 for preparing NH₂—NC514 are shown in FIG. 2A and FIG. 2B. The structural formula of the prepared NH₂—NC514 polymer is shown in FIG. 1, in which the chemical sites where the reaction can occur are marked with boxes or circles. The structural formula of the NH₂—NC514 polymer given in FIG. 1 actually represents the repeating unit of the NH₂—NC514 polymer. The reaction sites in the box of FIG. 1 are continuously connected with the reaction sites in the box of poly-NC514 in FIG. 2A, and the reaction sites in the circle of FIG. 1 are continuously connected with the reaction sites in the circle of hydrolyzed KH550 in FIG. 2B.

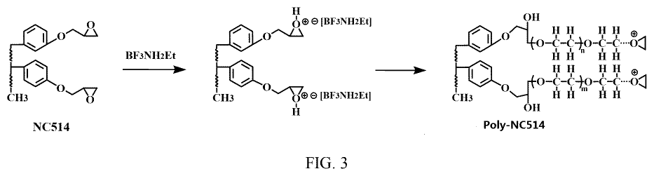

The chemical reaction formula of poly-NC514 prepared from reactant poly-NC514 and hydrolyzed KH550 is shown in FIG. 3, where [symbol] in both NC514 and poly-NC514 represent alkane chain —(CH₂)₆—. According to the reaction formula in FIG. 3, the proton generated by BF₃NH₂Et can induce the epoxy ring to open, so as to carry out the self-polymerization of NC514.

### Embodiment 1

A preparation of NH₂—NC514 includes following steps:
S1, dissolving KH550 in an ethanol solution with a volume concentration of 60% (the ethanol solution is formed by mixing anhydrous ethanol and deionized water at a volume ratio of 3:2), and magnetically stirring for 30 min at room temperature to complete the hydrolysis process to obtain hydrolyzed KH550, where a dissolution concentration of KH550 in the ethanol solution is 2 wt. %;
S2, dissolving cationic initiator BF₃NH₂Et and NC514 in acetone (BF₃NH₂Et and NC514 are completely dissolved, and there are no specific requirements for a dosage of acetone), and vigorously stirring for 5 min at room temperature to initiate a self-polymerization of NC514 to obtain poly-NC514 (the weight-average molecular weight is 1395 g/mol), where a dosage of BF₃NH₂Et is 2 wt. % of a dosage of NC514; and
S3, dissolving the poly-NC514 in the hydrolyzed KH550, continuously stirring by magnetic force for 30 min at room temperature, and carrying out grafting reaction; after the grafting reaction are completed, drying a reaction solution in a vacuum oven at 80° C. for 12 h to obtain NH₂—NC514 (a number average molecular weight is about 8000 g/mol after detection), where a mass ratio of the hydrolyzed KH550 to the poly-NC514 is 1:1.

### Comparative Embodiment 1

A preparation of NH₂-ESO includes following steps:
S1, dissolving KH550 in an ethanol solution with a volume concentration of 60% (the ethanol solution is formed by mixing anhydrous ethanol and deionized water at a volume ratio of 3:2), and magnetically stirring for 30 min at room temperature to complete a hydrolysis process to obtain hydrolyzed KH550, where a dissolution concentration of KH550 in the ethanol solution is 2 wt. %;
S2, dissolving cationic initiator BF₃NH₂Et and ESO (epoxy soybean oil, weight-average molecular weight is about 1000 g/mol) in acetone, and vigorously stirring for 5 min at room temperature to initiate self-polymerization of ESO to obtain poly-ESO, where a dosage of BF₃NH₂Et is 2 wt. % of a dosage of ESO; and
S3, dissolving poly-ESO in hydrolyzed KH550, continuously stirring by magnetic force for 30 min at room temperature, and carrying out grafting reaction; after the grafting reaction are completed, drying a reaction solution in a vacuum oven at 80° C. for 12 h to obtain NH₂-ESO, where a mass ratio of hydrolyzed KH550 to poly-ESO is 1:1.

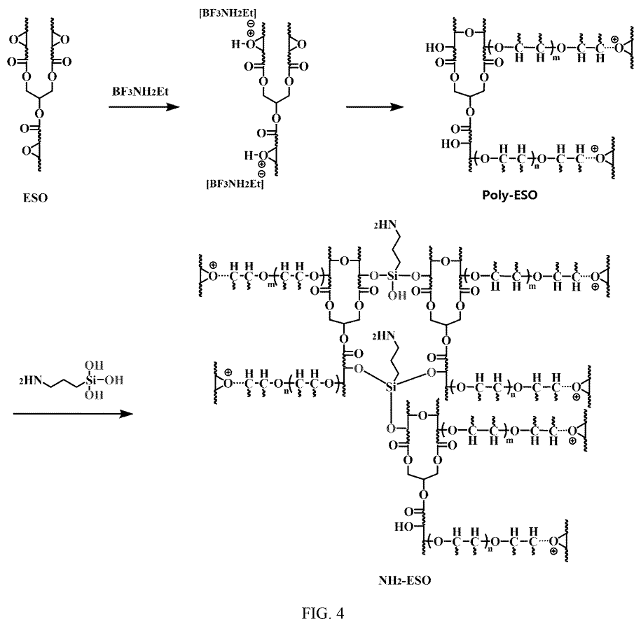

A chemical reaction formula of NH₂-ESO is shown in FIG. 4, where [symbol] represents alkane chain, but does not mean the same as alkane in NH₂—NC514 structural formula.

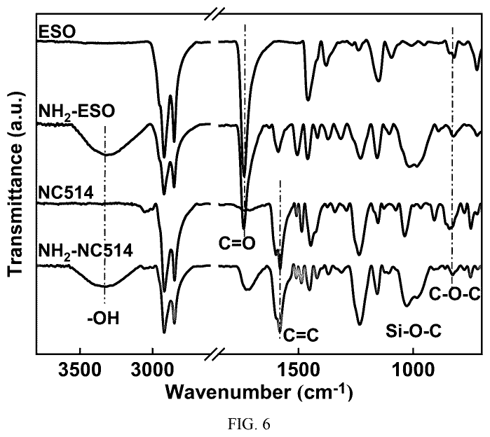

FIG. 6 is an infrared spectrum (FTIR) diagram of NH₂—NC514 prepared in Embodiment 1 of the present application, NH₂-ESO prepared in Comparative embodiment 1, and raw materials NC514 and ESO. It can be observed from FIG. 6 that a characteristic peak of carbonyl ester group C═O in ESO and NH₂-ESO structures appears at 1740 cm⁻¹; however, the C═C characteristic peak of benzene ring skeleton carbon-carbon double bond in NC514 and NH₂—NC514 structures appears at 1580 cm⁻¹. A self-polymerization of ESO and NC514 resulted in the change of a bending vibration characteristic peak of C—O—C located at 850 cm⁻¹, the appearance of a tensile vibration characteristic peak of Si—O—C at 1030 cm⁻¹ and a characteristic peak of —OH at 3300 cm⁻¹, which indicate that hydrolyzed KH550 is successfully grafted on the surfaces of poly-ESO and poly-NC514, and NH₂-ESO and NH₂—NC are successfully prepared.

### Application Embodiment 1

A preparation of a 3D printing composite material includes following steps:
S1, preparing of raw material: 70 parts of PLA, 30 parts of BFs and 4 parts of NH₂—NC514 (as a compatilizer) prepared in Embodiment 1;
S2, mixing PLA, BFs and the compatilizer at room temperature for 30 min at 60 rpm, and then mixing with an internal mixer at 60 rpm at 190° C. for 8 min to obtain a mixed material, namely a 3D printing composite material, named as PLA/BFs/4NH₂—NC514.

### Application Embodiment 2

Compared with Application embodiment 1, a only difference is that a dosage of NH₂—NC514 is 8 parts, and a prepared 3D printing composite material is named as PLA/BFs/8NH₂—NC514.

### Comparative Application Embodiment 1

Compared with Application embodiment 1, only difference is that NH₂-ESO prepared in Comparative embodiment 1 is used as a compatilizer instead of NH₂—NC514, and a prepared 3D printing composite is named PLA/BFs/4NH₂-ESO.

### Comparative Application Embodiment 2

Compared with Application embodiment 2, an only difference is that NH₂-ESO prepared in Comparative Embodiment 1 is used as a compatilizer instead of NH₂—NC514, and a prepared 3D printing composite is named PLA/BFs/8NH₂-ESO.

### Comparative Application Embodiment 3

Compared with Application Embodiment 1, an only difference is that no compatilizer is added, and a 3D printing composite material is named as PLA/BFs.

### Test Embodiment 1

Using chloroform as a solvent, BFs is extracted from 3D printing composite (2 g) by Soxhlet extraction at 80° C. After drying at 80° C. for 24 h, a surface microstructure and chemical analysis of the extracted BFs are carried out.

Test method: a change of the surface microstructure of BFs is observed by scanning electron microscope (SEM), and the change is observed on TESCAN VEGA 11 with an accelerating voltage of 10 kV.

Surface chemical properties of BFs are revealed by X-ray photoelectron spectroscopy (XPS). XPS experiment is carried out on ESCALAB 250Xi XPS equipment with Al Kα radiation source. An atomic high-resolution spectrum is obtained, and a passing energy is 70.0 eV, with an increment of 0.2 eV. Using XPS Peak 4.0 software to analyze C1s spectrum.

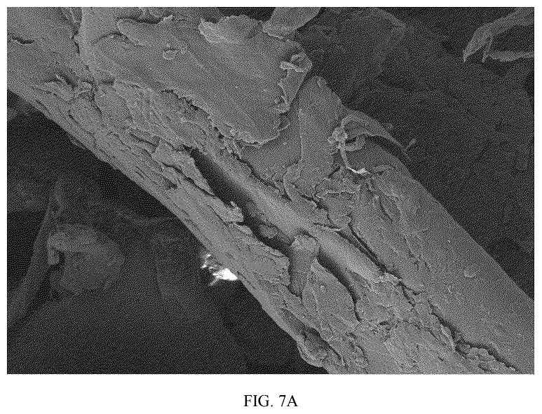

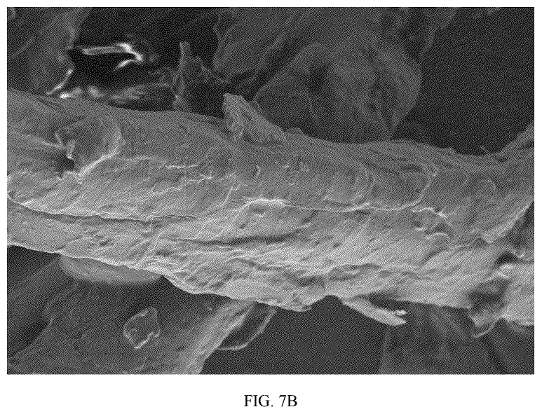

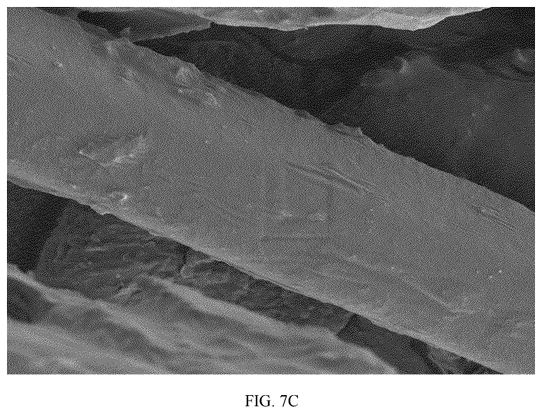

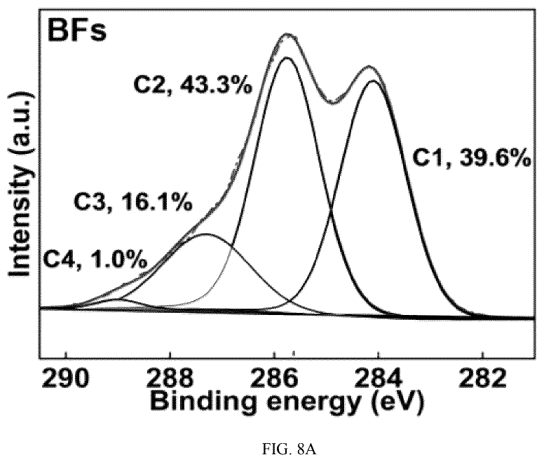

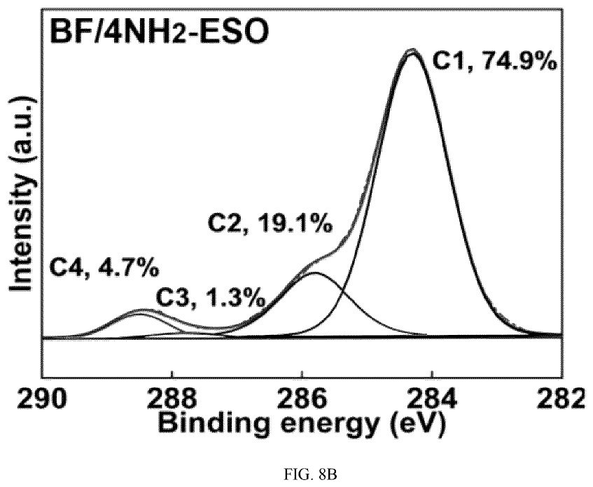

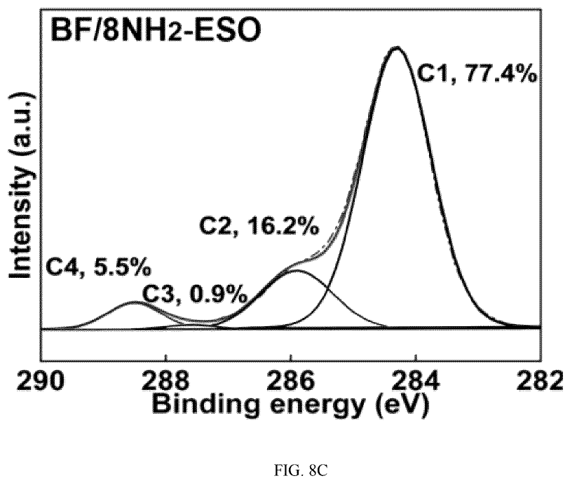

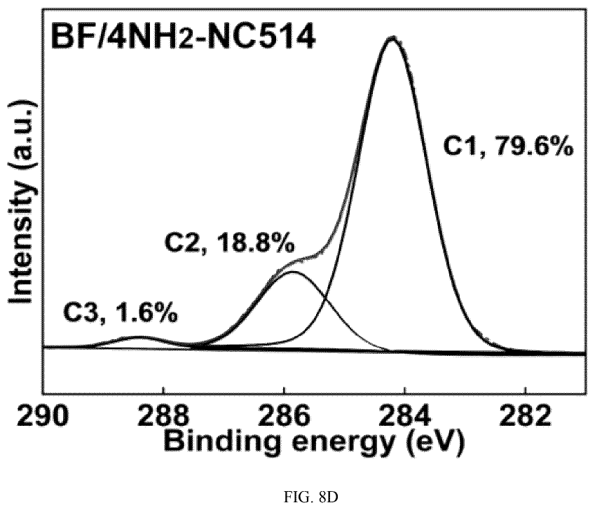

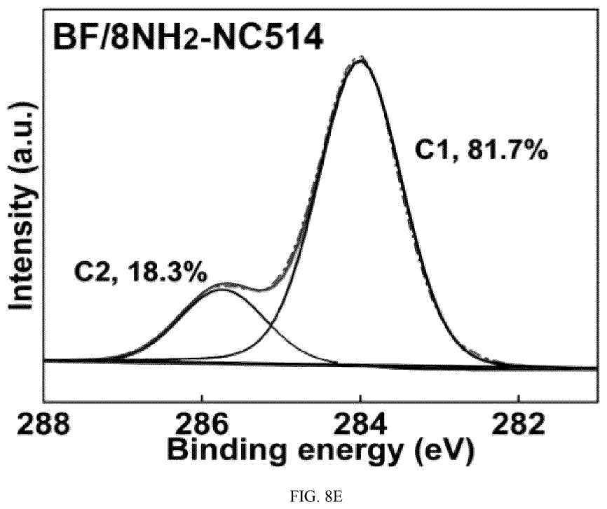

Test results: test results are shown in FIG. 7A, FIG. 7B, FIG. 7C, FIG. 8A, FIG. 8B FIG. 8C, FIG. 8D, and FIG. 8E.

FIG. 7A is a surface SEM image of bamboo fibers (BFs) extracted from the 3D printing composite material prepared in Comparative Application Embodiment 3; FIG. 7B is a surface SEM image of BFs/4NH₂-ESO extracted from the 3D printing composite material prepared in Comparative Application Embodiment 1; and FIG. 7C is a surface SEM image of BFs/4NH₂—NC514 extracted from the 3D printing composite material prepared in Application embodiment 1. It can be seen from FIG. 7A, FIG. 7B, and FIG. 7C that BFs without compatibilizers show rough fiber surface, while after adding compatibilizers NH₂-ESO and NH₂—NC514, it can be observed that the fiber surface is relatively smooth. This is mainly because the lignin and hemicellulose on the fiber surface are removed during the extraction process, which leads to the appearance of groove-like invagination. After adding compatibilizers, the invagination is filled by the formed flexible layer of compatibilizer. Because active groups in NH₂—NC514 structure have higher reactivity with polar groups on the surface of BFs, NH₂—NC514 is uniformly attached to the surface of BFs, and the fiber surface is smoother.

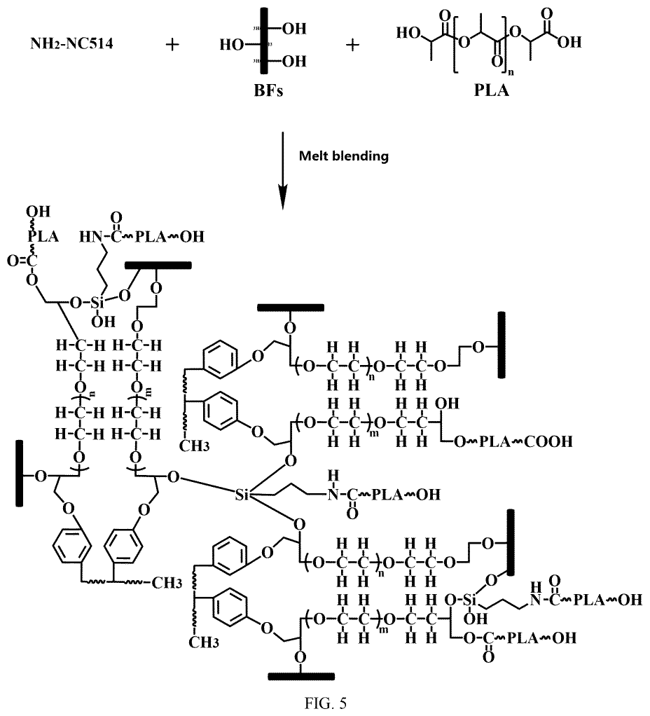

A reaction mechanism (only chemical sites where reactions may occur are shown) for preparing 3D printing composite material is shown in FIG. 5. As shown in the reaction mechanism for preparing 3D printing composite material, during a melt compounding process, following reactions mainly occur because NH₂—NC514 and NH₂-ESO are attached to the surface of BFs and located at the interface between BFs and PLA matrix: (1) a —OH group of BFs is used as a ring-opening agent of epoxy group in the compatibilizer structure, forming covalent bonds between BFs and compatibilizer; (2) the —OH group of BFs is substituted with the —OH group in the compatibilizer structure; (3) the epoxy group in the compatibilizer structure reacts with the terminal —COOH or —OH group of PLA, resulting in a chemical bond between the compatibilizer and PLA; and (4) an amino group in the compatilizer structure reacts with the terminal —COOH group of PLA.

FIG. 8A is a curve resolution XPS C1s spectrogram of BFs extracted from the 3D printing composite material prepared in Comparative application embodiment 3; FIG. 8B is a curve resolution XPS C1s spectrogram of BFs/4NH₂-ESO extracted from the 3D printing composite material prepared in Comparative application embodiment 1; FIG. 8C is a curve resolution XPS C1s spectrogram of BFs/4NH₂-ESO extracted from the 3D printing composite material prepared in Comparative application embodiment 2; FIG. 8D is a curve resolution XPS C1s spectrogram of BFs/4NH₂—NC514 extracted from the 3D printing composite material prepared in Application embodiment 1; and FIG. 8E is a curve resolution XPS C1s spectrogram of BFs/4NH₂—NC514 extracted from the 3D printing composite material prepared in Application embodiment 2. It can be seen from FIG. 8A, FIG. 8B, FIG. 8C, FIG. 8D, and FIG. 8E that natural BFs has four typical C components, namely C1 (C—C/C—H), C2 (C—O), C3 (C═O/O—C—O) and C4 (O—C—O), in which C2 is mainly derived from cellulose, and other components are closely related to non-cellulose substances such as hemicellulose and lignin. A ratio of C1:C2:C3:C4 in BFs is 1:1.09:0.41:0.03 (FIG. 8A). The C component proportion of PLA (a terminal group of PLA can be ignored) is 1:1:0:1; and a structure of NH₂—NC514 does not contain C3 and C4 components, and a structure of NH₂-ESO does not contain C3 components, which leads to a decrease or even disappearance of C3 content with an increase of compatibilizer dosage (FIG. 8B, FIG. 8C, FIG. 8D, and FIG. 8E). With the increase of compatilizer dosage, the content of C1 increased, which is due to a grafting of fatty chain in the structure of compatilizer and —CH₃ group of PLA. The C4 content of BFs/8NH₂—NC514 is basically disappeared because NH₂—NC514 is uniformly attached to the BFs surface.

### Test Embodiment 2

### Crystallization Performance Test

DSC (Differential Scanning calorimetry) measures a crystallinity of polymer. Crystallinity refers to a proportion of crystalline regions in polymer, and crystallinity is one of the important parameters for evaluating polymer properties. Through DSC test, a heat change of polymer during crystallization is measured to evaluate a crystallization performance of polymer.

Test method: TA instrument (TA2500) is used at the N₂ flow rate of 50 mL/min. 7 mg of a 3D printing composite material sample prepared in Application embodiment 1-2 and Comparative application embodiment 1-3 are sealed in a covered aluminum pot for testing. For scanning, the sample is heated from 30° C. to 200° C. at a rate of 10° C./min, and two consecutive scans are tested.

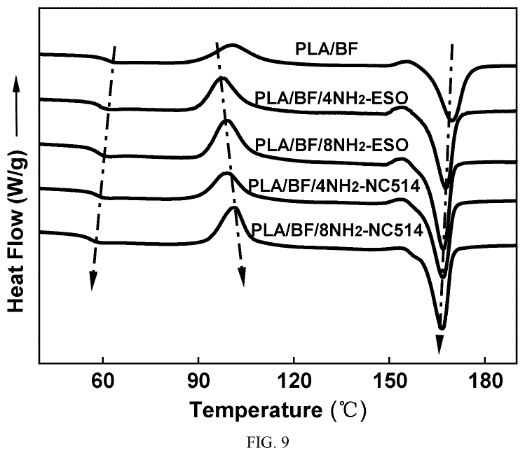

Test results: test results are shown in FIG. 9 and Table 1.

TABLE 1
DSC crystallization data

| | Tg | Tcc | ΔHcc | Tm | ΔHm | Xc |
|---|---|---|---|---|---|---|
| Sample | (° C.) | (° C.) | (J/g) | (° C.) | (J/g) | (%) |
| Application embodiment 1 | 57.9 | 99.2 | 12.4 | 166.8 | 22.2 | 17.5 |
| (PLA/BFs/4NH₂-NC514) | | | | | | |
| Application embodiment 2 | 55.9 | 101.3 | 14.3 | 166.6 | 21.4 | 12.6 |
| (PLA/BFs/8NH₂-NC514) | | | | | | |
| Comparative application | 59.1 | 97.7 | 14.2 | 167.6 | 23 | 15.7 |
| embodiment 1 | | | | | | |
| (PLA/BFs/4NH₂-ESO) | | | | | | |
| Comparative application | 57.8 | 99.3 | 16.4 | 167 | 23.5 | 12.6 |
| embodiment 2 | | | | | | |
| (PLA/BFs/8NH₂-ESO) | | | | | | |
| Comparative application | 60.7 | 101.1 | 11.4 | 169.6 | 20.8 | 16.7 |
| embodiment 3 (PLA/BFs) | | | | | | |

FIG. 9 is a DSC secondary temperature rise curve of 3D printing composite material prepared by Application embodiments 1-2 and Comparative application embodiments 1-3 (BF in figures represents the same meaning as BFs). As shown in FIG. 9 and Table 1, a glass transition temperature (Tg), melting temperature (Tm) and crystallinity (Xc) of 3D printing composites modified by compatibilizer show a decreasing trend with the increase of compatibilizer content, and a cold crystallization temperature (Tcc) shows an increasing trend, and the trend of the change of the material with NH₂—NC514 as the compatibilizer is more obvious. The decrease of Tg usually means that the material can change from glassy state to high elastic state at low temperature, and the change makes the material more prone to deformation when subjected to external force, thus improving toughness of the material. The decrease of Tm and the increase of Tcc are helpful to reduce energy consumption, reduce production cost and processing difficulty and improve production efficiency. Low crystallinity is helpful to improve a fluidity of material, making it easy for material to fill a mold or an extruder head during injection molding, extrusion and other processing processes, and reducing defects and rejection rates.

### Test Embodiment 3

### Dynamic Mechanical Analysis

Test method: the 3D printing composite material prepared in Application embodiments 1-2 and Comparative application embodiments 1-3 are subjected to dynamic mechanical analysis (the composite material is crushed and made into standard splines with the shape of 40 mm×10 mm×1 mm by micro injection molding machine for experimental test), which are conducted on DMA7100 TA instrument, with stretching mode of 30-110° C., heating rate of 2° C./min and frequency of 1 Hz.

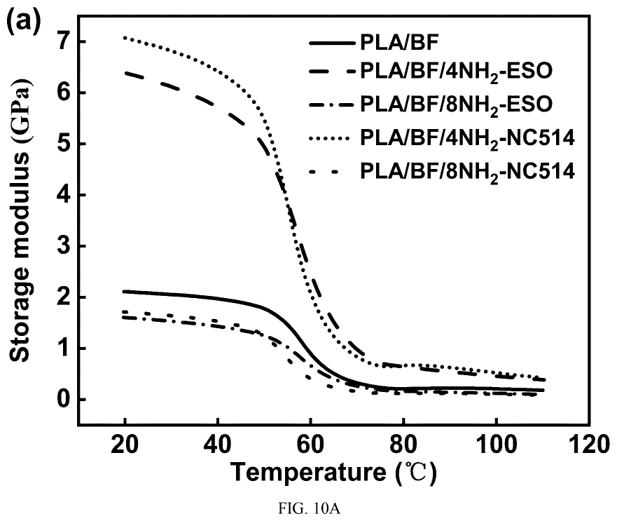

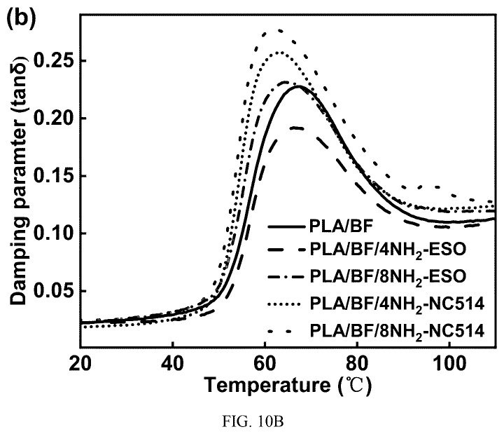

Test results: test results are shown in Table 2, FIG. 10A, and FIG. 10B.

TABLE 2
E′ and Tg of 3D printing composite material

| | E′ at 30° C. | Tg |
|---|---|---|
| Sample | (GPa) | (° C.) |
| Application embodiment 1 | 6.8 | 63.1 |
| (PLA/BFs/4NH₂-NC514) | | |
| Application embodiment 2 | 1.6 | 61.9 |
| (PLA/BFs/8NH₂-NC514) | | |
| Comparative application embodiment 1 | 6.1 | 66.2 |
| (PLA/BFs/4NH₂-ESO) | | |
| Comparative application embodiment 2 | 1.5 | 64.3 |
| (PLA/BFs/8NH₂-ESO) | | |
| Comparative application embodiment 3 | 2.1 | 67.7 |
| (PLA/BFs) | | |

FIG. 10A is a DMA curve of storage modulus of 3D printing composite material prepared by Application embodiments 1-2 and Comparative application embodiments 1-3 and FIG. 10B is a DMA curve of damping parameter of 3D printing composite material prepared by Application embodiments 1-2 and Comparative application embodiments 1-3. As can be seen from Table 2, FIG. 10A, and FIG. 10B, when the content of compatibilizer is 4 parts, the storage modulus (E′) of the composite material is greater than the PLA/BFs composite without modified by adding compatibilizer. When the content of compatibilizer is 8 parts, the E′ of the composite is smaller than the PLA/BFs composite without modified by adding compatibilizer. This is mainly because the epoxy group in the compatibilizer reacts with the polar group of BFs and the terminal carboxyl group of PLA to form a cross-linked network polymer, and cross-linking will enhance the rigidity of the material and lead to the increase of E′. Excessive compatilizer is solidified in PLA matrix to form elastomer, which has a significant impact on the toughness of PLA. Elastomer will destroy the dense structure of PLA amorphous region, thus reducing the E′ of the material. The E′ value of PLA/BFs/NH₂—NC514 is higher than that of PLA/BFs/NH₂-ESO, because NH₂—NC514 can form a network structure with PLA molecular chain, which makes the composite material have strong storage elastic deformation ability. For Tg, DSC (Table 1) way more directly reflects the change of heat capacity of materials during glass transition, while DMA focuses on the change of mechanical properties (especially viscoelasticity) of material. There are differences between DSC and DMA in testing principle, concerned physical quantities and curve expression, but they can both measure the Tg of material effectively. The peak temperature of the damping parameter in DMA test is the Tg of the composite material, and the test results are basically consistent with DSC. The Tg of PLA/BFs/NH₂—NC514 is lower than the PLA/BFs/NH₂-ESO with the same compatibilizer content.

### Test Embodiment 4

### Mechanical Performance Test

Test method: after the 3D printing composite material (mixed material obtained after internal mixing) is crushed by a crusher, dumbbell-shaped tensile spline (GB/T 1040-92) and impact spline (GB/T 1843-2008) are made by a micro injection molding machine at a barrel temperature of 200° C. and a mold temperature of 120° C. Dumbbell-shaped tensile spline and impact spline prepared from 3D printing composite material in Application embodiments 1-3 and Comparative application embodiments 1-3 are placed in laboratory environment for 24 h, and then tensile test is carried out according to GB/T 1040.2-2006 (IDT ISO 527.2-2:1993) with a tensile speed of 10 mm/min. According to GB/T 9341-2008 (IDT ISO 178-2001), a universal testing machine is used for bending test, the test speed is 2 mm/min and the specified deflection is 6 mm. According to the requirements of GB/T 1843-2008 (IDT ISO 180-2000), the notched impact test is carried out with a cantilever impact tester with 1J hammer.

Test results: test results are shown in Table 3.

TABLE 3
Mechanical properties of 3D printing composite material

| | Tensile | Tensile | Flexural | Flexural | Elongation | Impact |
|---|---|---|---|---|---|---|
| | strength | modulus | strength | modulus | at break | strength |
| Sample | (MPa) | (GPa) | (MPa) | (GPa) | (%) | (KJ/m³) |
| Application embodiment 1 | 35.7 ± 0.49 | 4.1 ± 0.24 | 62.1 ± 1.74 | 2.4 ± 0.06 | 15.6 ± 0.28 | 20 ± 0.43 |
| (PLA/BFs/4NH₂-NC514) | | | | | | |
| Application embodiment 2 | 28.9 ± 0.63 | 3.3 ± 0.31 | 50.3 ± 3.05 | 2.1 ± 0.09 | 23.2 ± 0.3 | 17 ± 0.28 |
| (PLA/BFs/8NH₂-NC514) | | | | | | |
| Comparative application | 28.3 ± 0.89 | 3.7 ± 0.26 | 52.2 ± 2.09 | 2.2 ± 0.12 | 28.4 ± 0.63 | 21.3 ± 0.46 |
| embodiment 1 | | | | | | |
| (PLA/BFs/4NH₂-ESO) | | | | | | |
| Comparative application | 27.3 ± 1.38 | 3.0 ± 0.25 | 49.5 ± 0.83 | 1.9 ± 0.17 | 23.3 ± 0.39 | 19 ± 0.31 |
| embodiment 2 | | | | | | |
| (PLA/BFs/8NH₂-ESO) | | | | | | |
| Comparative application | 38.10 ± 1.56 | 5.65 ± 0.19 | 71.77 ± 2.33 | 4.09 ± 0.17 | 3.81 ± 0.21 | 7.75 ± 0.30 |
| embodiment 3 | | | | | | |
| (PLA/BFs) | | | | | | |

Strength, toughness and stiffness are considered as the key factors to characterize the mechanical properties of composite material, and these properties must be carefully balanced when selecting 3D printing materials. However, in most cases, strength and toughness take precedence, especially in various general 3D printing applications. Selecting materials with high strength will ensure that the printed parts have enough resistance, thus minimizing the risk of deformation or damage. In actual use, the components may encounter impacts from different directions and strengths. In this case, materials with high toughness can withstand deformation without cracking, thus obtaining superior overall performance. From Table 3, it can be seen that the strength and stiffness of the composite material are slightly decreased and the toughness is greatly improved with the addition of compatibilizer. Compared with NH₂-ESO, NH₂—NC514's shorter alkane chain length and higher reactivity make the composite material achieve a balance between strength and stiffness, which is mainly reflected in the effective coverage of BFs surface and the entanglement with PLA matrix molecular chain during processing.

### Test Embodiment 5

### Rheological Property Test

Test method: rheological properties of the samples are run on MCR-502 of Anton Paar. The temperature is 210° C., and 40 points are selected in the range of 0.01-100 rad/s.

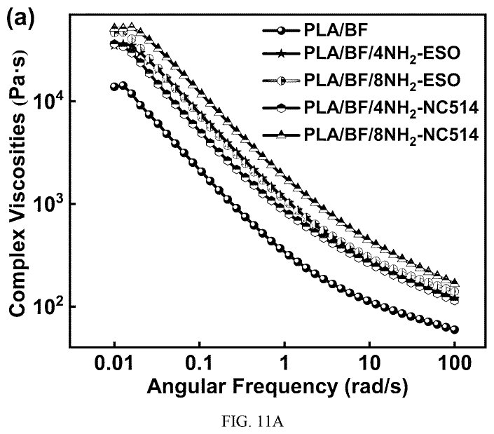

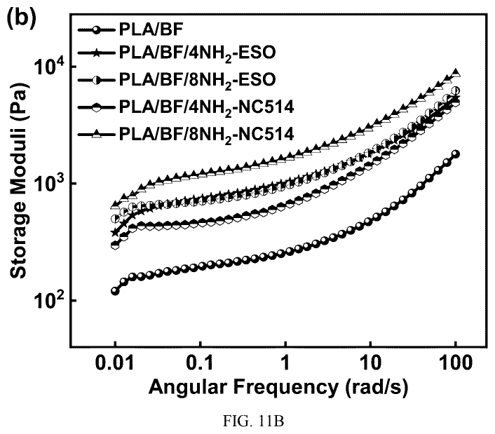

Test results: test results are shown in FIG. 11A and FIG. 11B.

FIG. 11A is a test curve of complex viscosities of rheological properties of 3D printing composite material prepared by Application embodiments 1-2 and Comparative application embodiments 1-3 and FIG. 11B is a test curve of storage modulus of rheological properties of 3D printing composite material prepared by Application embodiments 1-2 and Comparative application embodiments 1-3. As can be seen from FIG. 11A and FIG. 11B, the melt rheological properties of composite material are directly related to the dispersion degree of fibers in polymer matrix and the level of interfacial interaction between fibers and polymers. The complex viscosity of PLA/BFs composite material without adding compatibilizer is lower than the composite material with compatibilizer. This is because the compatibilizer can improve the interfacial compatibility of the composite material and increase the entanglement with PLA. The change trend of storage modulus is basically consistent with complex viscosity. With the increase of compatibilizer content, the complex viscosity and storage modulus show an upward trend. This is because the interaction between compatibilizer and polymer matrix and bamboo fiber greatly hinder the migration of polymer chain and the entanglement degree of compatibilizer molecular chain itself increases with the increase of content.

### Test Embodiment 6

### Interface Compatibility Test

Test method: the changes of impact fracture surface and surface microstructure after impact fracture of impact spline in Test embodiment 4 are observed by scanning electron microscope (SEM), and are observed on TESCAN VEGA 11 with accelerated voltage of 10 kV. In order to comprehensively evaluate the interfacial bonding strength of 3D printing composite material and the dispersibility of compatilizer in 3D printing composite material, 3D printing composite material (impact spline) are soaked in toluene for three days after impact fracture, and then the changes of impact fracture surface and surface microstructure are observed by SEM.

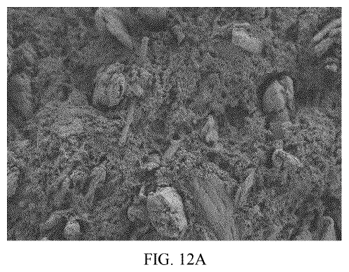

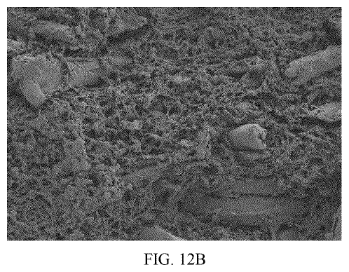

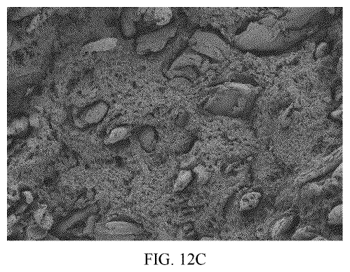

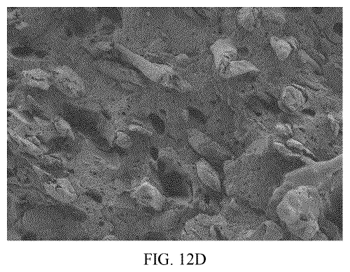

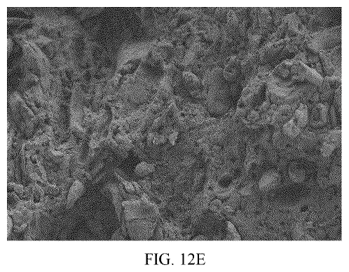

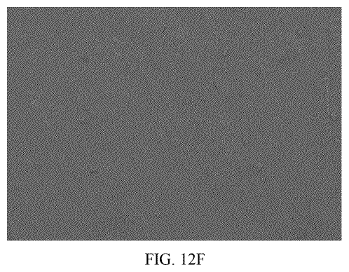

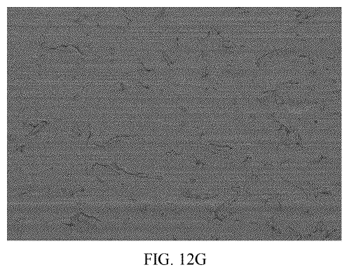

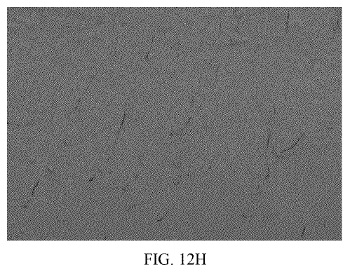

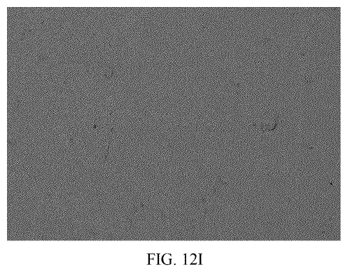

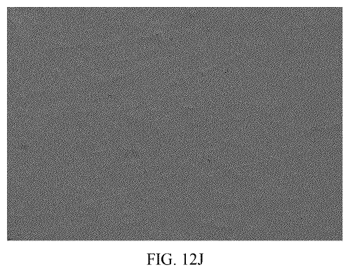

Test results: test results are shown in FIG. 12A, FIG. 12B, FIG. 12C, FIG. 12D, FIG. 12E, FIG. 12F, FIG. 12G, FIG. 12H, FIG. 12I, FIG. 12J.

FIG. 12A is a section SEM image of polylactic acid (PLA)/BFs of impact fracture of impact spline prepared by using the 3D printing composite material in Application embodiments 1-2 and Comparative application embodiments 1-3; FIG. 12B is a section SEM image of PLA/BFs/4NH₂-ESO of impact fracture of impact spline prepared by using the 3D printing composite material in Application embodiments 1-2 and Comparative application embodiments 1-3; FIG. 12C is a section SEM image of PLA/BFs/8NH₂-ESO of impact fracture of impact spline prepared by using the 3D printing composite material in Application embodiments 1-2 and Comparative application embodiments 1-3; FIG. 12D is a section SEM image of PLA/BFs/4NH₂—NC514 of impact fracture of impact spline prepared by using the 3D printing composite material in Application embodiments 1-2 and Comparative application embodiments 1-3; FIG. 12E is a section SEM image of PLA/BFs/8NH₂—NC514 of impact fracture of impact spline prepared by using the 3D printing composite material in Application embodiments 1-2 and Comparative application embodiments 1-3; FIG. 12F is a surface SEM image of PLA/BFs of impact fracture of impact spline prepared by using the 3D printing composite material in Application embodiments 1-2 and Comparative application embodiments 1-3; FIG. 12G is a surface SEM image of PLA/BFs/4NH₂-ESO of impact fracture of impact spline prepared by using the 3D printing composite material in Application embodiments 1-2 and Comparative application embodiments 1-3; FIG. 12H is a surface SEM image of PLA/BFs/8NH₂-ESO of impact fracture of impact spline prepared by using the 3D printing composite material in Application embodiments 1-2 and Comparative application embodiments 1-3; FIG. 12I is a surface SEM image of PLA/BFs/4NH₂—NC514 of impact fracture of impact spline prepared by using the 3D printing composite material in Application embodiments 1-2 and Comparative application embodiments 1-3; and FIG. 12J is a surface SEM image of PLA/BFs/8NH₂—NC514 of impact fracture of impact spline prepared by using the 3D printing composite material in Application embodiments 1-2 and Comparative application embodiments 1-3. As can be seen from FIG. 12A, FIG. 12B, FIG. 12C, FIG. 12D, FIG. 12E, FIG. 12F, FIG. 12G, FIG. 12H, FIG. 12I, FIG. 12J, for the 3D printing composite material (PLA/BFs) modified without adding compatilizer, a large number of deep grooves are generated during the fiber pull-out process, indicating that the interfacial adhesion between BFs and PLA is weak. After adding compatibilizer, an indistinguishable fiber matrix interface appeared on the impact fracture surface, which confirmed that compatibilizer improved the interface bonding of composites. In contrast, the surface of samples modified by NH₂—NC514 remained relatively smooth after soaking, and there are no obvious cracks. SEM analysis of PLA/BFs/NH₂-ESO after soaking shows that there are a lot of pores in the matrix, which is caused by leaching of NH₂-ESO. However, PLA/BFs/NH₂—NC514 has fewer cavities in the matrix, and there is no obvious gap between PLA and BFs, which indicates that PLA/BFs/NH₂—NC514 shows enhanced reactivity, in which NH₂—NC514 forms chemical bonds with the matrix and BF surface, and remains stable even after long-term solvent exposure, which is consistent with the mechanical properties discussed above.

### Test Embodiment 7

### Machinability and Appearance Quality Test

The 3D printing composite material in Application embodiment 1 and Comparative application embodiment 1 are crushed by a crusher to obtain pellets, and then the pellets are sent to a single-screw extruder to form thermoplastic filaments with a diameter of 1.75±0.03 mm, and the temperature range of the single-screw extruder is set at 175-180 C.

After observation, the thermoplastic filaments prepared by using the 3D printing composite material in Application embodiment 1 are smooth and uniform in diameter, while the surface of the thermoplastic filaments prepared by using the 3D printing composite material in Comparative application embodiment 1 is uneven, so that 3D printing cannot be realized and nozzle clogging will occur.

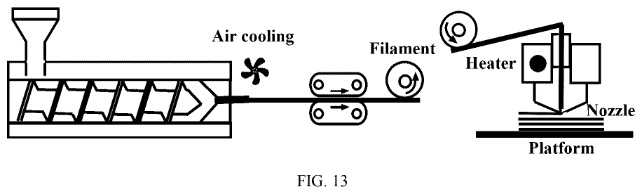

The thermoplastic filaments prepared from the 3D printing composite material in Application embodiment 1 are used to produce 3D printed products by FDM printer. During the FDM printing process, the thermoplastic filaments are transformed into viscous flow state and extruded from the nozzle to the supporting platform layer by layer. Parameters of FDM printer are set as follows: nozzle temperature 210° C., platform temperature 80° C., printing speed 40 mm/s and layer thickness 0.1 mm, and 3D printing products are obtained. FIG. 13 is a schematic diagram of thermoplastic filaments extruded by a single screw extruder and then printed in 3D. Complex thin-walled hollow structures can be produced through the above 3D printing process without supporting structures and platform accessories. The printing process is smooth and the model looks good.

Using the 3D printing composite materials PLA/BFs/4NH₂—NC514 and PLA in Application embodiment 1 as 3D printing raw materials, thin square sheet samples with a side length of 10 mm and a thickness of 4 mm are prepared, and the heat resistance of the samples is compared. The results show after the pure PLA sheet is heated at 80° C. for 30 min, the sheet (edge area) is irreversibly deformed. In contrast, under the same conditions, the sheet prepared by PLA/BFs/4NH₂—NC514 has no obvious thermal deformation, indicating that the durability to thermal deformation is enhanced. Moreover, compared with pure PLA, the density (from 1.31 g/cm³ to 1.28 g/cm³) and water absorption (from 1.1% to 0.65%) of PLA/BFs/4NH₂—NC514 are decreased, which shows that the durability of PLA/BFs/4NH₂—NC514 is better than PLA, plus the additional benefit of reducing raw material consumption.

The determination of water absorption refers to GB/T 1034-2008. The sample is dried in an oven at 50° C. for 24 h, cooled to room temperature in a dryer and weighed (mass m₁). The samples are immersed in distilled water at 23° C. for 25 h, then removed, the surface water stains are wiped off and weighed again (mass m₂). The water absorption (C) of the sample can be expressed as:

$$C = \frac{{m}_{2} - {m}_{1}}{{m}_{1}} \times 100 \% .$$

See GB/T 1033.1—2008 for the determination of density. Samples with metal wires suspended in air are weighed, and samples with metal wires suspended in air are immersed in a beaker containing distilled water on a stationary stand, and the samples are weighed in the distilled water. The density (ρ_{S}) of the sample can be expressed as:

$${ρ}_{S} = \frac{{m}_{S , A} \times {ρ}_{IL}}{{m}_{S , A} - {m}_{S , IL}}$$

Among them, (ρ_{S}) is a density of the sample, m_{S,A} is a mass of the sample in the air, m_{S,IL} is an apparent mass of the sample and ρ_{IL} is a density of distilled water.

The above-mentioned embodiments only describe the preferred mode of the application, and do not limit the scope of the application. Under the premise of not departing from the design spirit of the application, various modifications and improvements made by ordinary technicians in the field to the technical scheme of the application shall fall within the protection scope determined by the claims of the application.

What is claimed is:

1. An aminated epoxy cardanol glycidyl ether, wherein a structural formula is: 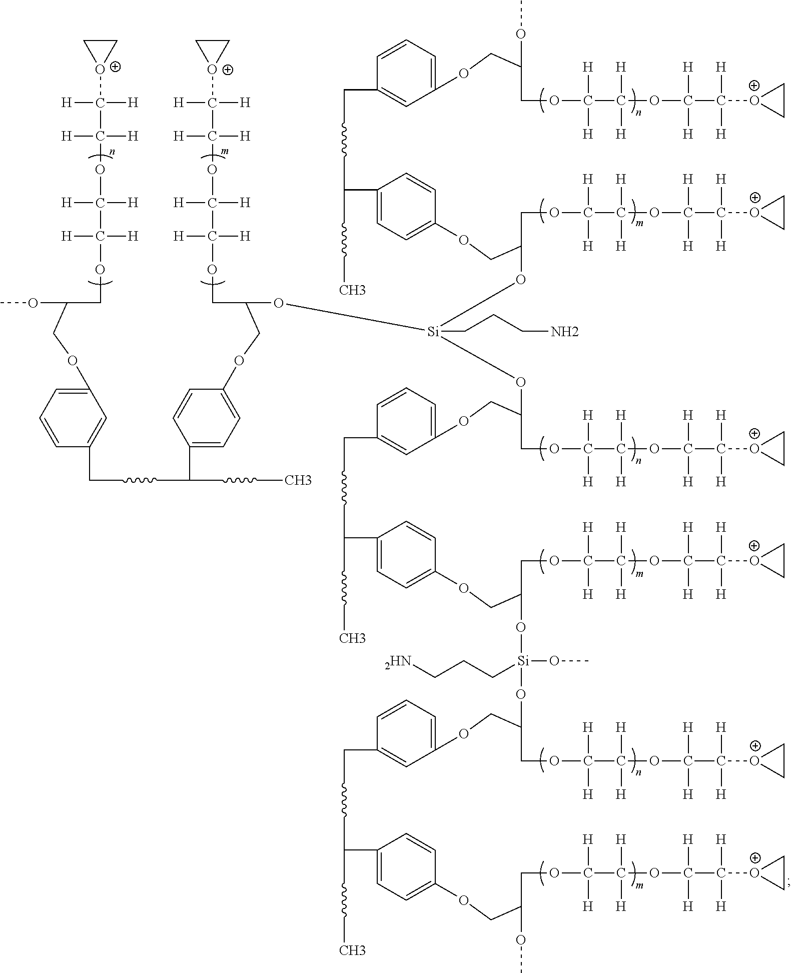
Wherein [symbol] stands for —(CH₂)₆—.

2. A preparation method of the aminated epoxy cardanol glycidyl ether according to claim 1, comprising following steps:
hydrolyzing 3-aminopropyl triethoxysilane to obtain hydrolyzed 3-aminopropyl triethoxysilane;
using a cationic initiator to initiate self-polymerization of epoxy cardanol glycidyl ether to obtain poly-epoxy cardanol glycidyl ether; and
taking the poly-epoxy cardanol glycidyl ether and the hydrolyzed 3-aminopropyl triethoxysilane as reactants, and carrying out a grafting reaction to obtain the aminated epoxy cardanol glycidyl ether.

3. The preparation method according to claim 2, wherein steps of hydrolyzing the 3-aminopropyl triethoxysilane comprises: dissolving the 3-aminopropyl triethoxysilane in an ethanol solution, and magnetically stirring for 30-90 minutes to complete a hydrolyzing reaction and obtain the hydrolyzed 3-aminopropyl triethoxysilane; and
a dissolved concentration of the 3-aminopropyl triethoxysilane in the ethanol solution is 2 wt. %.

4. The preparation method according to claim 2, wherein steps of using the cationic initiator to initiate the self-polymerization of the epoxy cardanol glycidyl comprises:
dissolving the cationic initiator and the epoxy cardanol glycidyl ether in a solvent, vigorously stirring for 5-10 minutes at room temperature, and initiating the self-polymerization of the epoxy cardanol glycidyl ether to obtain the poly-epoxy cardanol glycidyl ether;
the cationic initiator is BF₃NH₂Et; and
a dosage of the cationic initiator is 1-2 wt. % of a dosage of the epoxy cardanol glycidyl ether.

5. The preparation method according to claim 2, wherein steps of carrying out the grafting reaction with the poly-epoxy cardanol glycidyl ether and the hydrolyzed 3-aminopropyl triethoxysilane as the reactants comprises: dissolving the poly-epoxy cardanol glycidyl ether in the hydrolyzed 3-aminopropyl triethoxysilane, and stirring for 30-60 minutes to complete the grafting reaction to obtain the aminated epoxy cardanol glycidyl ether; and
a mass ratio of the poly-epoxy cardanol glycidyl ether to the hydrolyzed 3-aminopropyl triethoxysilane is 3-1:1-3.

6. A 3D printing composite material, comprising following raw materials in parts by mass: 70 parts of polylactic acid, 30 parts of bamboo fibers and 2-8 parts of compatilizer; wherein the compatilizer is the aminated epoxy cardanol glycidyl ether according to claim 1.

7. A preparation method of the 3D printing composite material according to claim 6, comprising following steps:
mixing the polylactic acid, the bamboo fibers and the compatilizer at the room temperature, and then carrying out banburying and mixing to obtain the 3D printing composite material.

8. A preparation method of a 3D printing product by using the 3D printing composite material according to claim 6, comprising following steps:
crushing the 3D printing composite material, and then melting and extruding the 3D printing composite material to obtain thermoplastic filaments; and carrying out 3D printing on the thermoplastic filaments to obtain the 3D printing product.

9. A 3D printing product prepared by the preparation method according to claim 8.
